(19) United States
(12) Patent Application Publication
(10) Pub. No.: US 2025/0243696 A1
(43) Pub. Date: Jul. 31, 2025

(54) VEHICLE DOOR HANDLE ASSEMBLY

(71) Applicant: Minebea AccessSolutions Italia S.p.A., Pianezza (IT)

(72) Inventors: Alexandre PIERI, Pianezza (IT); Simon ROUZET, Pianezza (IT); Antonio ROCCI, Pianezza (IT); Simone ILARDO, Pianezza (IT)

(73) Assignee: Minebea AccessSolutions Italia S.p.A., Pianezza (IT)

(21) Appl. No.: 19/034,889

(22) Filed: Jan. 23, 2025

(30) Foreign Application Priority Data
Jan. 25, 2024 (EP) 24153986.5

(51) Int. Cl. E05B 77/06; E05B 85/16

(52) U.S. Cl. CPC E05B 77/06; E05B 85/16

(57) ABSTRACT

A vehicle door handle assembly includes a rotatable lever for rotating around a first axis between a rest position and an active position for opening the vehicle door, an inertial blocking mechanism including a first inertial mass for rotating around a second axis between a rest position and an active position, a second inertial mass for rotating around the second axis between a rest position and an active position, a first stop for stopping the rotation of the first inertial mass when the first inertial mass is in its active position, and a second stop for stopping the rotation of the second inertial mass when the second inertial mass is its active position. The rotation of the first inertial mass is associated with a first predetermined acceleration. The rotation of the second inertial mass is associated with a second predetermined acceleration higher than the first acceleration.

### TECHNICAL FIELD

The present invention relates to the field of vehicle door handles to control the opening of vehicle doors and in particular to an inner door handle assembly.

### BACKGROUND OF THE INVENTION

The present invention refers to a vehicle door handle assembly comprising an inertial mechanism configured for blocking the opening of the door in case of a crash of the vehicle.

To comply with the security standards, in particular in case of side crashes, the side vehicle door handles may be equipped with an inertial system. Such inertial system is triggered in case of a side crash of the vehicle and blocks the handle lever to prevent from any opening of the door which could lead to an ejection of a passenger outside the vehicle.

However, due to the large range of accelerations that may be undergone during a crash, it is particularly difficult to design an inertial mechanism that enables an efficient blocking of the vehicle door during a small crash (associated with a small acceleration, for example <10 G) while not preventing the opening of the door after such small crash and that also enables an efficient blocking of the vehicle door in case of a big crash (associated with a high acceleration, for example >20 G)

It is therefore an aim of the present invention to provide a vehicle door handle assembly that is reliable and efficient to block the opening of the door in a wide range of crashes (associated to a wide range of accelerations).

### SUMMARY OF THE INVENTION

The present invention refers to a vehicle door handle assembly comprising:
a rotatable lever configured for rotating around a first axis between a rest position and an active position for opening the vehicle door,
a inertial blocking mechanism comprising:
a first inertial mass configured for rotating around a second axis between a rest position and an active position wherein the first inertial mass is configured for blocking the rotation of the rotatable lever in its active position, the rotation of the first inertial mass being associated with a first predetermined acceleration,
a second inertial mass configured for rotating around the second axis between a rest position and an active position wherein the first and the second inertial masses comprise an overlapping part so that the second inertial mass pushes the first inertial mass towards its active position when the second inertial mass is rotated towards its active position, the rotation of the second inertial mass being associated with a second predetermined acceleration higher than the first acceleration,
a first stop configured for stopping the rotation of the first inertial mass when the first inertial mass is in its active position,
a second stop configured for stopping the rotation of the second inertial mass when the second inertial mass is its active position.

The use of a first stop and a second stop enables preventing the inertial mechanism to be broken or damaged during a crash which would lead to a dysfunction of the inertial blocking mechanism and therefore the possibility of an opening of the door during a crash.

According to another aspect of the present invention, the first stop is configured for stopping the rotation of the first inertial mass at a first predetermined angular position and the second stop is configured for stopping the rotation of the second inertial mass at a second predetermined angular position which is different than the first predetermined angular position.

Such difference may enable taking into account the flexion of the pin associated with the second inertial mass due to the accelerations undergone by the first and the second inertial masses.

According to another aspect of the present invention, the second inertial mass comprise a pin extending towards the first inertial mass and overlapping the first inertial mass.

According to another aspect of the present invention, the pin of the second inertial mass extends parallel to the second axis.

According to another aspect of the present invention, the inertial blocking mechanism also comprises:
a first elastic mean configured for constraining the first inertial mass in its rest position,
a second elastic mean configured for constraining the second inertial mass in its rest position.

According to another aspect of the present invention, the first and the second elastic means are helicoidal springs and wherein the first and the second inertial masses comprise a support recess configured for receiving an end of the respectively first and second helicoidal springs in order to preload the first and the second helicoidal springs before assembly of the helicoidal springs on the vehicle door handle assembly.

According to another aspect of the present invention, the inertial blocking mechanism is reversible.

According to another aspect of the present invention, the inertial blocking mechanism also comprises a flexible plate configured for interacting with a hook of the second inertial mass for blocking the rotation of the second inertial mass when the second inertial mass is in the active position.

According to another aspect of the present invention, the first inertial mass is configured for rotating when the undergone acceleration is larger than 2 G, for example 4 G and the second inertial mass is configured for rotating when the undergone acceleration is larger than 25 G, for example 31 G.

According to another aspect of the present invention, the rotatable lever is linked to a first end of a Bowden cable, the second end of the Bowden cable being linked to a door lock, the rotation of the rotatable lever towards the active position leading to a displacement of the Bowden cable and the blocking of the door lock in a closed position.

According to another aspect of the present invention, the vehicle door handle assembly also comprises a gripping handle configured to be rotated by a user, the rotatable lever and the gripping handle being rotatably coupled so that a rotation of the gripping handle leads to the rotation of the rotatable lever and conversely.

The present invention also refers to a vehicle door comprising a vehicle door handle assembly as described previously.

According to another aspect of the present invention, the door is a side door.

### BRIEF DESCRIPTION OF THE DRAWINGS

FIG. 1 is a perspective view of a part of a door handle mechanism according to an embodiment of the present invention;

FIG. 2 is a perspective view of an inertial blocking mechanism according to an embodiment of the present invention;

FIG. 3 is a side view of the inertial blocking mechanism of FIG. 2 in a rest position;

FIG. 4 is a side view of the inertial blocking mechanism of FIG. 2 in an active position;

FIG. 5 is a perspective view of a door handle mechanism according to an embodiment of the present invention wherein the inertial blocking mechanism is irreversible;

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

The present invention refers to a vehicle door handle assembly 1 and in particular a vehicle side door handle assembly.

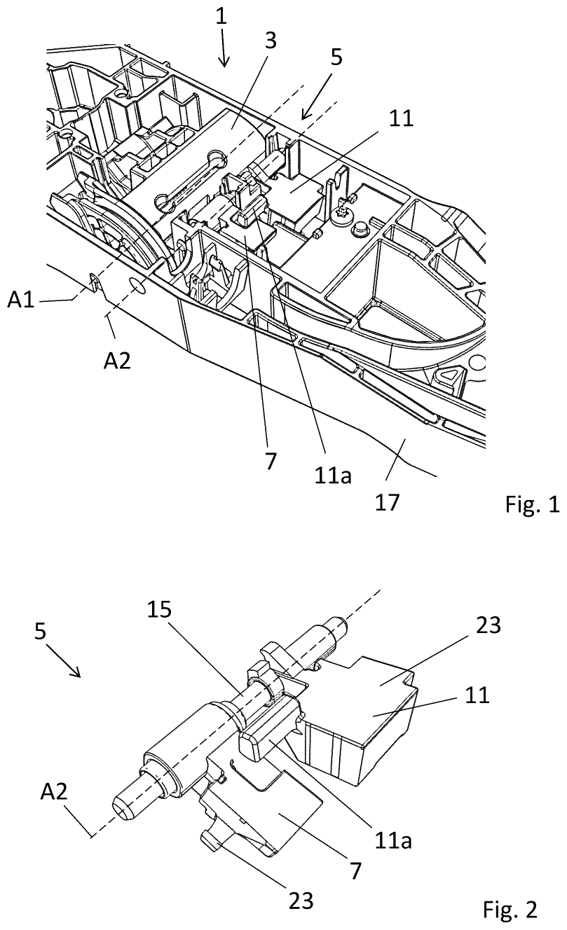

FIG. 1 represents a part of a vehicle door handle assembly according to an embodiment of the present invention. As represented in FIG. 1, the vehicle door assembly 1 comprises a rotatable lever 3 configured for rotating around a first axis of rotation noted A1 between a rest position and an active position for opening the vehicle door. The rotatable lever 3 may be associated with a Bowden cable linked to a latch or door lock.

The rotatable lever 3 may be linked to a first end of a Bowden cable, the second end of the Bowden cable being linked to the latch or door lock, the rotation of the rotatable lever 3 towards the active position leading to a displacement of the Bowden cable and the opening of the door lock. Alternatively, it is possible that an electrical lock is installed, whereby the rotatable lever 3 can activate an electric actuating device (e.g. a switch), whereby this electrical actuating device is electrically connected to an electrical door lock, whereby the rotation of the rotatable lever 3 in the direction of the active position leads to an activation of the electrical actuating device, which sends an electrical signal to the lock and unlocks it. As long as the electrical actuating device is not activated, the electric door lock is blocked in a closed position.

The vehicle door handle assembly 1 may also comprise a gripping handle configured to be gripped and rotated by a user. The rotatable lever 3 and the gripping handle are rotatably coupled so that a rotation of the gripping handle leads to the rotation of the rotatable lever 3 and conversely so that a blocking of rotation of the rotatable lever 3 blocks the rotation of the gripping handle.

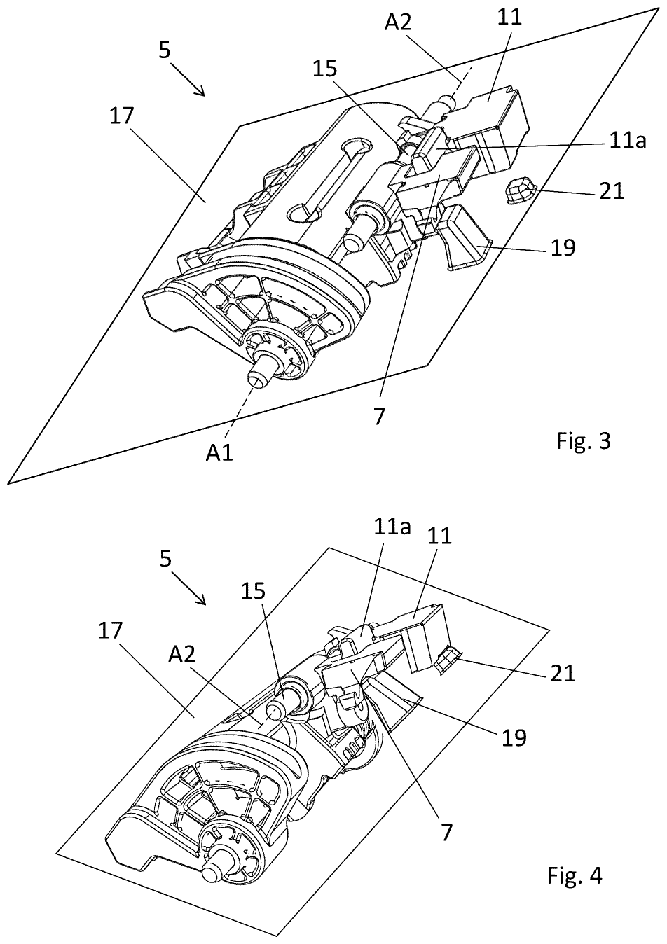

The vehicle door handle assembly 1 also comprises an inertial blocking mechanism 5 configured to prevent from an opening of the door in case of a crash, in particular in case of a side crash. The inertial blocking mechanism 5 comprises a first inertial mass 7 configured for 20 rotating around a second axis noted A2 between a rest position represented in FIG. 3 and an active position represented in FIG. 4. In the active position, the first inertial mass 7 blocks the rotation of the rotatable lever 3. The inertial blocking mechanism 5 also comprises a first elastic mean (not represented) such as an helicoidal spring associated with the first inertial mass 7. The first elastic mean is configured for constraining the first inertial mass 7 in its rest position.

The parameters associated with the first inertial mass 7 such as its weight, its mass distribution with respect to the second axis A2 and the spring stiffness of the associated first elastic mean are chosen so that the rotation of the first inertial mass 7 is associated with a first predetermined acceleration corresponding to a small crash. The first predetermined acceleration may be comprised in a range from 5 G to 10 G, for example 6 G.

The inertial blocking mechanism 5 also comprises a second inertial mass 11 configured for rotating around the second axis A2 between a rest position represented in FIG. 3 and an active position represented in FIG. 4. The second inertial mass 11 comprise a portion that overlaps the first inertial mass 7. The second inertial mass 11 may comprise a pin 11a that overlaps the first inertial mass 7 so that the second inertial mass 11 is configured for pushing the first inertial mass 7 towards its active position when the second inertial mass 11 is rotated towards its active position. Thus, when the second inertial mass 11 is rotated in its active position, it leads to a blocking of the rotation of the rotatable lever 3 via the action of the pin 11a on the first inertial mass 7 and the blocking of the rotation of the rotatable lever 3 by the first inertial mass 7. The pin 11a extends for example parallel to the second axis A2.

Alternatively, the pin may be arranged on the first inertial mass (on the opposite side than the pin 11a of the second inertial mass 11) so that the second inertial mass 11 pushes the pin of the first inertial mass 7 when the second inertial mass 11 rotates towards its active position. The overlapping part may also have a shape different than a pin.

The inertial blocking mechanism 5 also comprises a second elastic mean such as a helicoidal spring associated with the second inertial mass 11. The second elastic mean is configured for constraining the second inertial mass 11 in its rest position.

The parameters associated with the second inertial mass 11 such as its weight, its mass distribution with respect to the second axis A2 and the spring stiffness of the associated first elastic mean are chosen so that the rotation of the second inertial mass 11 is associated with a second predetermined acceleration, higher than the first acceleration, corresponding to a big crash. The second predetermined acceleration may be higher than 25 G, for example 30 G or higher.

The inertial blocking mechanism 5 can be seen in more details in FIG. 2. The inertial blocking mechanism 5 comprises a rod 15 associated with the second axis A2 and configured for being hold at its ends in a housing 17 (visible in FIG. 1) of the vehicle door handle assembly 1. The ends of the rod 15 are for example disposed in recesses arranged in the housing 17.

The first inertial mass 7 and the second inertial mass 11 are mounted rotatably on the rod 15. The first inertial mass 7 and the second inertial mass 11 may comprise a support recess such as a hook 23 configured for receiving a first end of respectively the first and the second elastic mean. The coils of the first and second elastic means may be arranged around the second axis A2 and their first end may extend perpendicular to the second axis A2 and lie against the hook 23. The second ends of the first and second elastic means may lie against an element which cannot rotate around the second axis A2 such as an element of the housing 17 or a ring tighten on the rod 15 and which does not rotate with respect to the second axis A2 even during a crash of the vehicle. Such configuration of the first and second inertial masses 7 and 11 and the first and second elastic means enables providing a preload of the first and second elastic mean when the inertial blocking mechanism 5 is positioned in the housing 17.

As represented in FIG. 3, the inertial blocking mechanism 5 also comprises a first stop 19 configured for stopping the rotation of the first inertial mass 7 when the first inertial mass 7 is in its active position and a second stop 21 configured for stopping the rotation of the second inertial mass 11 when the second inertial mass 11 is in its active position.

The first stop 19 is configured for stopping the rotation of the first inertial mass 7 at a first predetermined angular position and the second stop 21 is configured for stopping the rotation of the second inertial mass 11 at a second predetermined angular position which is different than the first predetermined angular position in order to take into account the flexion of the pin 11a associated with the second inertial mass 11 due to the accelerations undergone by the first 7 and the second 11 inertial masses.

According to a first embodiment, the inertial blocking mechanism 5 is reversible so that the first 7 and second 11 inertial masses are brought back to their rest position after any types of undergone accelerations.

According to a second embodiment, the inertial blocking mechanism is irreversible when the second inertial mass 11 move to its active position.

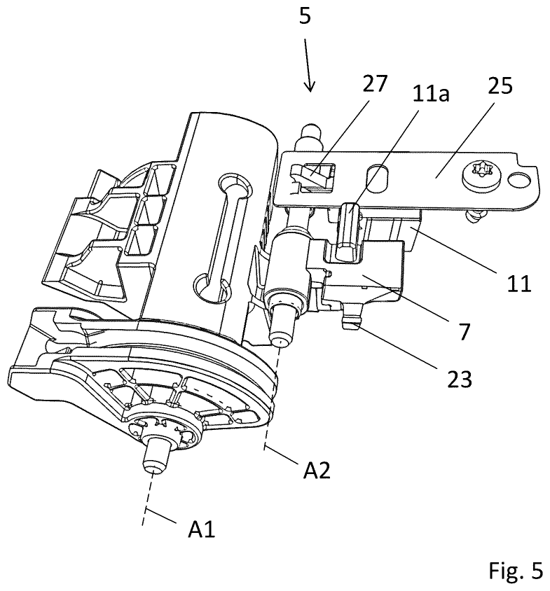

In this embodiment, as represented in FIG. 5, the inertial blocking system 5 comprises a flexible plate 25 configured for interacting with a hook 27 of the second inertial mass 11 for blocking the rotation of the second inertial mass 11 when the second inertial mass 11 is in the active position. The flexible plate 25 may comprise an opening configured for receiving the hook 27 when the second inertial mass 11 moves to its active position. The hook 27 is for example configured for pushing the flexible plate 25 when the second inertial mass 11 moves towards its active position. The flexible plate 25 is bent until the hook 27 reaches the opening of the flexible plate 25. The second inertial mass 11 is then retained in its active position by the flexible plate 25. Such irreversible embodiment may be use to avoid an opening of the door after the crash.

Thus, in functioning, in normal conditions, the first 7 and the second 11 inertial masses remain in their rest position as represented in FIG. 1 so that the user may open and close the door (when the latch is unlocked), for example by pulling on the gripping handle.

In case of a small crash (for example with an acceleration around 10 G), the first inertial mass 7 is rotated towards its active position to the first stop 19 and blocks the rotation of the rotatable lever 3 and therefore prevents the opening of the door during the crash. The first stop 19 prevents the first inertial mass 7 from rotating too much which could lead to a degradation or a breakage of the other parts of the vehicle door handle assembly 1. The first stop 19 may also be used to damp a possible rebound of the first inertial mass 7 towards its rest position.

After the crash, the first inertial mass 7 returns to its rest position under the action of the first elastic mean so that the user may open the door again after the small crash.

In case of a big crash (for example with an acceleration around 30 G), the second inertial mass 11 is rotated towards its active position to the second stop 21 as represented in FIG. 4. The second stop 21 prevents the second inertial mass 11 from rotating too much which could lead to a degradation or a breakage of the other parts of the vehicle door handle assembly 1. The second stop 21 may also be used to damp a possible rebound of the second inertial mass 11 towards its rest position.

The second inertial mass 11 drags along the first inertial mass 7 towards its active position thanks to the pin 11a (the first inertial mass 7 may bounce forth and back between the pin 11a and its active position but ends at its active position under the action of the second inertial mass 11) so that the rotatable lever 3 is blocked and cannot rotate during the big crash. With the reversible embodiment of the inertial blocking mechanism 5, the first 7 and the second 11 inertial masses return to their rest position after the crash and the door can be opened again. With the irreversible embodiment shown in FIG. 5, the second inertial mass 11 is blocked in its active position by the elastic plate 25. The first inertial mass 7 is therefore also blocked in its active position which prevents the opening of the door even after the crash. In order to unblock the inertial blocking mechanism 5, the plate 25 needs to be remove in order to free the second inertial mass 11 and allow the first 7 and the second 11 inertial masses to return to their rest position.

The present invention also refers to a vehicle door, in particular a vehicle side door, comprising a door handle assembly as described previously.

Thus, the use of an inertial blocking mechanism 5 made of a double pendulum with a first inertial mass 7 configured to react to small crashes and a second inertial mass 11 configured 5 to react to big crashes enables providing an inertial blocking mechanism 5 efficient on a large range of accelerations. The inertial blocking mechanism 5 is reversible at least for small crashes. Furthermore, the use of two stops 9, 11 (associated with the first 7 and the second 11 inertial masses) that are shifted in position enables reducing the constraints applied on the pin 11a which could lead to a degradation or a breakage of the said pin 11a.

1-12. (canceled)

13. A vehicle door handle assembly, comprising:
a rotatable lever configured to rotate around a first axis between a rest position and an active position for opening the vehicle door; and
an inertial blocking mechanism comprising:
a first inertial mass configured to rotate around a second axis between a rest position and an active position, wherein the first inertial mass is configured to block the rotation of the rotatable lever in its active position, the rotation of the first inertial mass being associated with a first predetermined acceleration,
a second inertial mass configured to rotate around the second axis between a rest position and an active position, wherein the first and the second inertial mass comprise an overlapping part so that the second inertial mass pushes the first inertial mass towards its active position when the second inertial mass is rotated towards its active position, the rotation of the second inertial mass being associated with a second predetermined acceleration higher than the first acceleration,
a first stop configured to stop the rotation of the first inertial mass when the first inertial mass is in its active position, and
a second stop configured to stop the rotation of the second inertial mass when the second inertial mass is its active position.

14. The vehicle door handle assembly in accordance with claim 13, wherein the first stop is configured to stop the rotation of the first inertial mass at a first predetermined angular position and the second stop is configured to stop the rotation of the second inertial mass at a second predetermined angular position which is different than the first predetermined angular position

15. The vehicle door handle assembly in accordance with claim 14, wherein the second inertial mass comprises a pin extending towards the first inertial mass and overlapping the first inertial mass.

16. The vehicle door handle assembly in accordance with claim 15, wherein the pin of the second inertial mass extends parallel to the second axis.

17. The vehicle door handle assembly in accordance with claim 13, wherein the inertial blocking mechanism further comprises:
first elastic means for constraining the first inertial mass in its rest position, and
second elastic means for constraining the second inertial mass in its rest position.

18. The vehicle door handle assembly in accordance with claim 17, wherein the first and the second elastic means are helicoidal springs and wherein the first and the second inertial masses comprise a support recess configured to receive an end of the respectively first and second helicoidal springs in order to preload the first and the second helicoidal springs before assembly of the helicoidal springs on the vehicle door handle assembly.

19. The vehicle door handle assembly in accordance with claim 13, wherein the inertial blocking mechanism is reversible.

20. The vehicle door handle assembly in accordance with claim 13, wherein the inertial blocking mechanism further comprises a flexible plate configured to interact with a hook of the second inertial mass to block the rotation of the second inertial mass when the second inertial mass is in the active position.

21. The vehicle door handle assembly in accordance with claim 13, wherein the first inertial mass is configured to rotate when the undergone acceleration is larger than 2 G and the second inertial mass is configured to rotate when the undergone acceleration is larger than 25 G.

22. The vehicle door handle assembly in accordance with claim 21, wherein the first inertial mass is configured to rotate when the undergone acceleration is 4 G.

23. The vehicle door handle assembly in accordance with claim 21, wherein the second inertial mass is configured to rotate when the undergone acceleration is 31 G.

24. The vehicle door handle assembly in accordance with claim 13, wherein the rotatable lever is linked to a first end of a Bowden cable, the second end of the Bowden cable being linked to a door lock, the rotation of the rotatable lever towards the active position leading to a displacement of the Bowden cable and the blocking of the door lock in a closed position.

25. The vehicle door handle assembly in accordance with claim 13, further comprising a gripping handle configured to be rotated by a user, the rotatable lever and the gripping handle being rotatably coupled so that a rotation of the gripping handle leads to the rotation of the rotatable lever and conversely.

26. A vehicle door, comprising:
the vehicle door handle assembly in accordance with claim 13.

27. The vehicle door in accordance with claim 26,
wherein the vehicle door is a side door.
